(19) United States
(12) Patent Application Publication
(10) Pub. No.: US 2016/0104573 A1
(43) Pub. Date: Apr. 14, 2016

(54) METHOD FOR MANUFACTURING PERMANENT MAGNET

(71) Applicant: Korea University Research and Business Foundation, Seoul (KR)

(72) Inventors: Seong-Rae Lee, Seoul (KR); Tae-Hoon Kim, Seoul (KR); Tae-Suk Jang, Cheonan (KR)

(73) Assignee: Korea University Research and Business Foundation

(21) Appl. No.: 14/974,707

(22) Filed: Dec. 18, 2015

Related U.S. Application Data
(63) Continuation of application No. PCT/KR2014/004647, filed on May 23, 2014.

(30) Foreign Application Priority Data
Jun. 18, 2013 (KR) 10-2013-0069517
Mar. 14, 2014 (KR) 10-2014-0030533

(51) Int. Cl. H01F 41/02; B22F 1/00; C22C 38/16; C22C 38/12; H01F 1/01; C22C 38/06; C22C 38/00; C22C 30/02; C22C 28/00; B22F 3/16; C22C 38/10

(52) U.S. Cl. CPC H01F 41/0266; B22F 3/16; B22F 1/0081; B22F 1/0003; C22C 38/16; C22C 38/12; C22C 38/10; C22C 38/06; C22C 38/005; C22C 38/002; C22C 30/02; C22C 28/00; H01F 1/01; H01F 41/0273; B22F 2301/10; B22F 2301/45; B22F 2301/20; B22F 2301/15; B22F 2301/052; B22F 2301/355

(57) ABSTRACT

Provided is a method for manufacturing an Nd—Fe—B-based permanent magnet having an improved coercive force while reducing the amount of Dy used. A method for manufacturing a permanent magnet according to an embodiment of the present invention may comprise the steps of: preparing powder including Nd, Fe, B, and Cu; preparing a shaped body by forming a specific magnetic field in the powder; sintering the shaped body at a specific sintering temperature; and subjecting the sintered, shaped body to annealing at a annealing temperature determined according to the content of Cu.

### CROSS-REFERENCE(S) TO RELATED APPLICATION

This application is a continuation of International Application No. PCT/KR2014/004647, filed on May 23, 2014, which claims priority to Korean Patent Application No. 10-2013-0069517, filed on Jun. 18, 2013 and No. 10-2014-0030533, filed on Mar. 14, 2014. The applications are hereby incorporated by reference.

### BACKGROUND OF THE INVENTION

1. Field of the Invention

The present invention relates to a method for manufacturing a permanent magnet. More particularly, it relates to a method for manufacturing an Nd—Fe—B-based permanent magnet having an improved coercive force while reducing the amount of dysprosium (Dy) used.

2. Description of the Related Art

An Nd—Fe—B-based permanent magnet has excellent magnetic characteristics, and therefore, its use is gradually expanding. In recent, as width of magnet application is widening by industrial apparatus, electric cars and wind powder generation as well as home appliances in response to environmental problems. Thus, high performance establishment of the Nd—Fe—B-based magnet is needed.

As a magnet performance index, there are residual magnetic flux density and size of coercive force. Increase of the residual magnetic flux density of the Nd—Fe—B-based sintered magnet is achieved by increase of volume rate of Nd₂Fe₁₄B compound and improvement of a degree of crystal orientation, and many processes have been improved until now. In regard of increase of coercive force, there are many approaches such as aiming crystal grain refining, using a composition alloy with increased Nd amount, or adding effective elements and the like. Among them, now the most general method is using a composition alloy, wherein a part of Nd is substituted with Dy or Tb. By substituting Nd of the Nd₂Fe₁₄B compound with these elements, an anisotropic magnetic field of the compound is increased, and coercive force is also increased. On the other hand, substitution by Dy or Tb reduces saturated magnetic polarization of the compound. Thus, with only aiming increase of coercive force by the said method, reduction of residual magnetic flux density is inevitable. Further, because Tb or Dy is expensive metal, it is preferred to reduce the amount used as much as possible.

As a related prior art, there is Korean Patent Laid-Open Publication No. 10-2010-0097580. The Publication No. 10-2010-0097580 discloses a fabrication method of a sintered magnet by repetitive heat treatment and a sintered magnet prepared thereby.

However, Korean Patent Laid-Open Publication No. 10-2010-0097580 does not disclose a method for improving coercive force and reducing the Dy content at the same time when manufacturing a permanent magnet.

Thus, when manufacturing a permanent magnet, there is a need to study about a technique for improving coercive force while reducing content of the expensive Dy

### SUMMARY OF THE INVENTION

An aspect of the present invention is directed to provide a method for manufacturing an Nd—Fe—B-based permanent magnet having an improved coercive force while reducing the amount of Dy used.

According to an embodiment of the present invention, provided is a method for manufacturing a permanent magnet, which comprises: preparing powder containing Nd, Fe, B and Cu; preparing a shaped body by forming a magnetic field on the powder; sintering the shaped body at a certain sintering temperature; and annealing the sintered shaped body at an annealing temperature, which is determined according to the Cu content.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a flow chart showing the method for manufacturing a permanent magnet according to one embodiment of the present invention;

FIG. 2 is a diagram to explain strip-casting and hydrogen treatment in the method for manufacturing a permanent magnet illustrated in FIG. 1;

FIG. 3 is a diagram to explain a process of milling a master alloy in the method for manufacturing a permanent magnet illustrated in FIG. 1;

FIG. 4 is a diagram to explain a process of preparing a shaped body in the method for manufacturing a permanent magnet illustrated in FIG. 1;

FIG. 5 is a diagram to explain a process of sintering in the method for manufacturing a permanent magnet illustrated in FIG. 1;

FIG. 6 and FIG. 7 are diagrams to explain effect of post-sintering annealing in the method for manufacturing a permanent magnet according to one embodiment of the present invention;

FIG. 8 shows performing sintering and annealing by a general method when manufacturing a permanent magnet;

FIG. 9 is a diagram showing relationship between the Cu content and coercive force;

FIG. 10 to FIG. 11 show microstructure of a triple point phase of a permanent magnet containing Cu;

FIG. 12 is a diagram to compare microstructures of Nd-rich grain boundary phases having different Cu contents;

FIG. 13 to FIG. 14 are diagrams to explain relationship between the Cu content and an annealing temperature;

FIG. 15 shows coercive force change and residual magnetization change of the sintered magnet containing 0.5 at % of Cu according to the first annealing temperature;

FIG. 16 is a diagram showing microstructures of specimens when annealing is conducted at the annealing temperature illustrated in FIG. 8 and the annealing temperature illustrated in FIG. 15;

FIG. 17 is an image obtained from FIG. 16(b) by using High-resolution transmission electron microscopy (HRTEM);

FIG. 18 is a graph showing change on magnetic characteristic according to the sintering temperature according to one embodiment of the present invention; and

FIG. 19 is a graph showing coercive force change according to the first annealing temperature change according to one embodiment of the present invention.

### DETAILED DESCRIPTION OF EXEMPLARY EMBODIMENTS

Hereinafter, the method for manufacturing a permanent magnet and a permanent magnet according to embodiments of the present invention will be described below in detail with reference to the accompanying drawings. Wherever possible, the same reference numerals will be used to refer to the same elements throughout the specification, and a duplicated description thereof will be omitted. It will be understood that although the terms “first”, “second”, etc. are used herein to describe various elements, these elements should not be limited by these terms. These terms are only used to distinguish one element from another element.

Incidentally, unless clearly used otherwise, expressions in the singular number include a plural meaning. In this application, the terms “comprising” and “including” should not be construed to necessarily include all of the elements or steps disclosed herein, and should be construed not to include some of the elements or steps thereof, or should be construed to further include additional elements or steps.

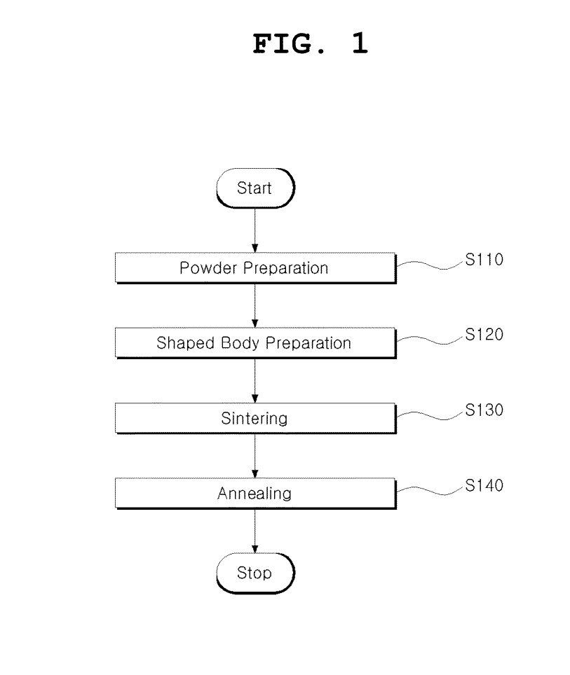

FIG. 1 is a flow chart showing the method for manufacturing a permanent magnet according to one embodiment of the present invention.

First of all, powder including Nd, Fe, B and Cu may be prepared (S110). The process for preparing the powder may comprise strip-casting, hydrogen treatment, milling and the like.

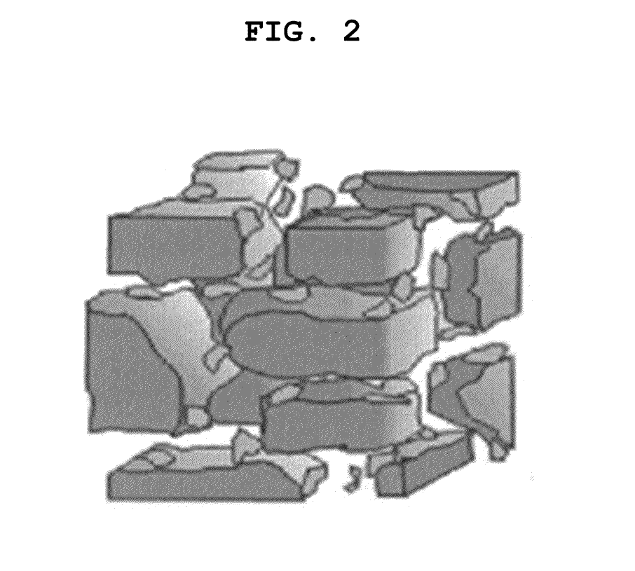

FIG. 2 is a diagram to explain strip-casting and hydrogen treatment in the method for manufacturing a permanent magnet illustrated in FIG. 1. In the following Examples, permanent magnets may be manufactured by varying ingredient composition according to the Dy content.

According to the first embodiment, a Strip-cast master alloy having composition of Nd_{12.00}Dy_{2.70}Fe_{(76.45-x)}CuₓB_{6.00}M_{2.65} (x=0.2, 0.3, 0.4, 0.5), (at %, M=Co, Al, and Nb) may be manufactured, and hydrogen treatment may be conducted. Volume of grain boundary may be changed by the process, so that milling to single crystal may become easy.

Further, according to the second embodiment, a Strip-cast master alloy having composition of Nd_{32.00}Fe_{(64.79-x)}CuₓB_{0.97}M_{2.24} (Dy-free) (x=0.2, 0.3, 0.4, 0.5), (at %, M=Co, Al, and Nb) may be manufactured, and hydrogen treatment may conducted. Volume of grain boundary may be changed by the process, so that milling to single crystal may become easy.

Further, according to the third embodiment, a Strip-cast master alloy having composition of Nd_{29.00}Dy_{3.00}Fe_{(64.79-x)}CuₓB_{0.97}M_{2.24} (3 wt % Dy-containing) (x=0.2, 0.3, 0.4, 0.5), (at %, M=Co, Al, and Nb) may be manufactured, and hydrogen treatment may conducted. Volume of grain boundary may be changed by the process, so that milling to single crystal may become easy.

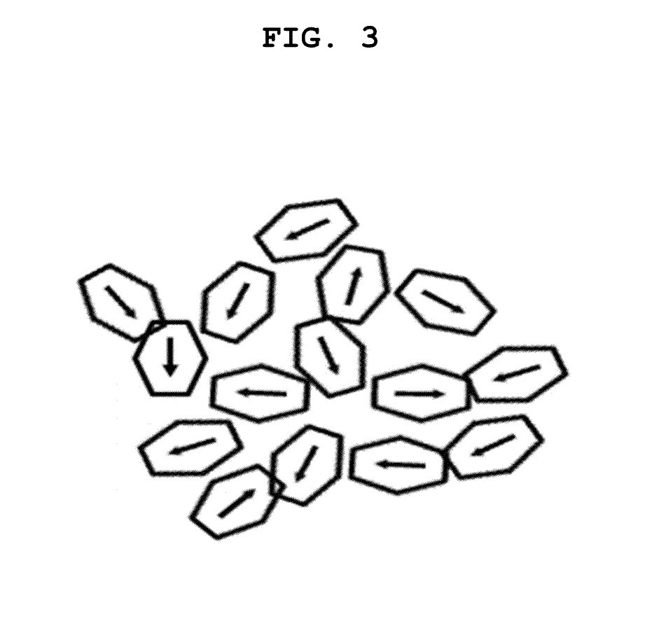

FIG. 3 is a diagram to explain a process of milling a master alloy in the method for manufacturing a permanent magnet illustrated in FIG. 1.

The master alloy illustrated in FIG. 2 may be milled using jet-milling. Ferromagnetic powder having single crystal may be manufactured by the milling process.

The Cu included in the powder reduces the melting point of the Nd-rich phase most efficiently. Preferably, the Cu content of may be 0.01 to 0.8 weight ratio based on the powder. If the Cu content of is more than 0.8 weight ratio based on the powder, density may be reduced, and if the content of Cu is less than 0.01 weight ratio based on the powder, effect of Cu addition may become slight.

When the ferromagnetic powder is prepared, a shaped body may be prepared by forming a specific magnetic field in the powder (S120).

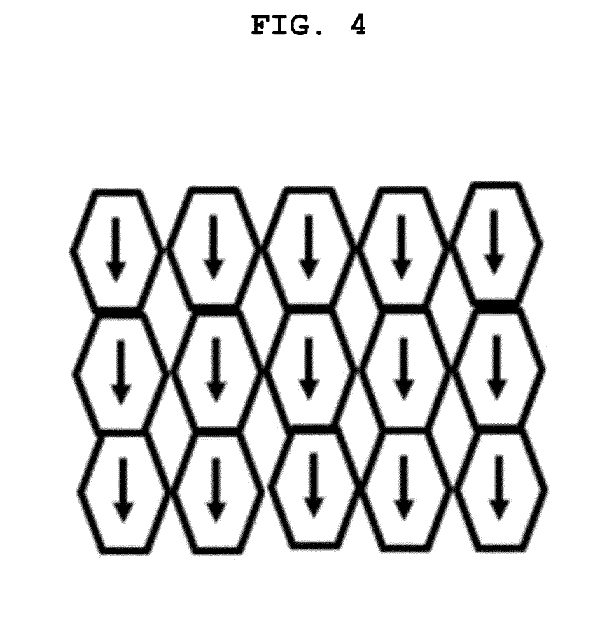

FIG. 4 is a diagram to explain a process of preparing a shaped body in the method for manufacturing a permanent magnet illustrated in FIG. 1.

As illustrated, a shaped body (Green compact) may be manufactured by pressurizing while applying a specific magnetic field (for example: about 2.2T) on the ferromagnetic powder. An easy magnetization axis of the prepared shaped body is arranged in one direction.

When the shaped body is manufactured, the shaped body may be sintered (S130).

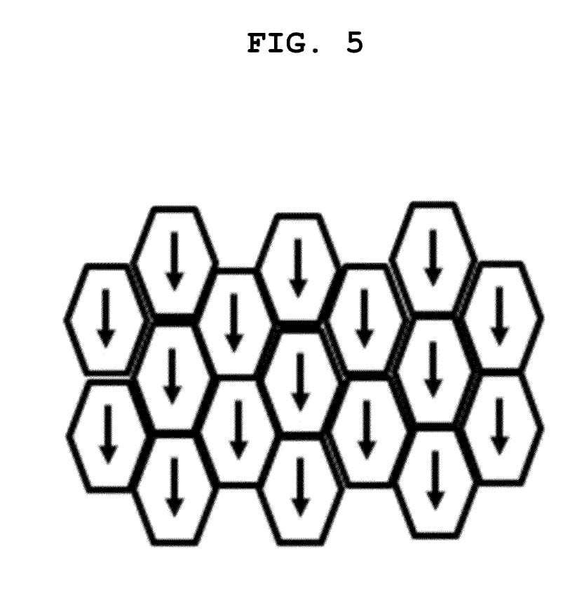

FIG. 5 is a diagram to explain a process of sintering in the method for manufacturing a permanent magnet illustrated in FIG. 1.

As illustrated, the shaped body may be sintered for several hours under a specific atmosphere. For example, the shaped body may be sintered for 4 hours at 1070° C. to 1040° C. under vacuum atmosphere. An ideal sintering temperature and sintering time may vary depending on composition and atmosphere, sintering furnace and the like. Liquid phase sintering may be proceeded until about 99% of densification is obtained. Through the sintering process, an anisotropic magnet having full density may be manufactured.

On the other hand, according to one embodiment of the present invention, the sintering temperature may vary depending on the Cu content.

After the sintering process, annealing may be conducted (S140). The annealing may be conducted once, but may be conducted several times to improve characteristics.

For example, after sintering, the annealing may be conducted three times to improve characteristics. An ideal annealing condition may vary depending on composition and environment. Mainly, it may be divided into high temperature annealing and low temperature annealing.

According to one embodiment of the present invention, the annealing may be conducted at different temperature according to the Cu content. As mentioned above, the permanent magnet having an improved coercive force while reducing the amount of Dy used may be manufactured by subjecting annealing at the annealing temperature determined by the Cu content. Further, when conducting the annealing several times, the annealing may be conducted at the annealing temperature determined by the Cu content only for the first annealing.

Hereinafter, the reason why the annealing temperature should be changed according to sintering annealing effects and the Cu content will be explained by experiments.

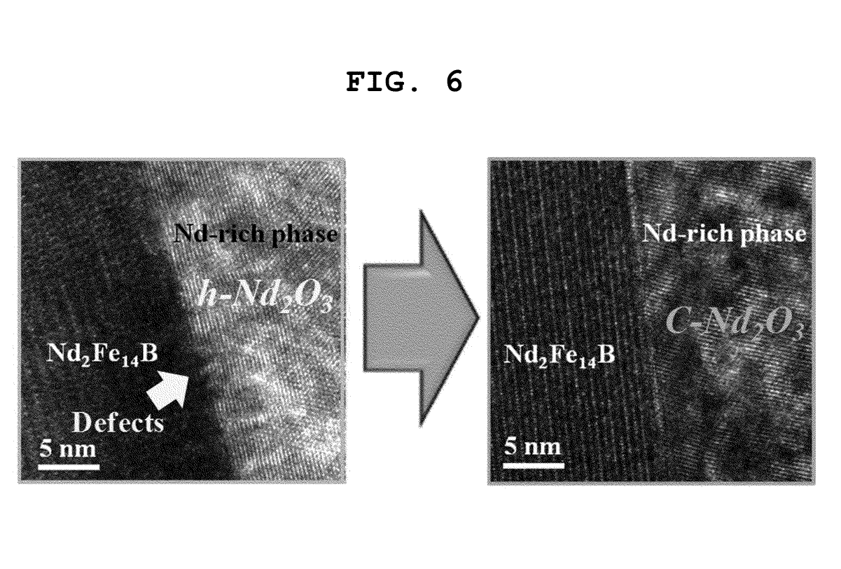

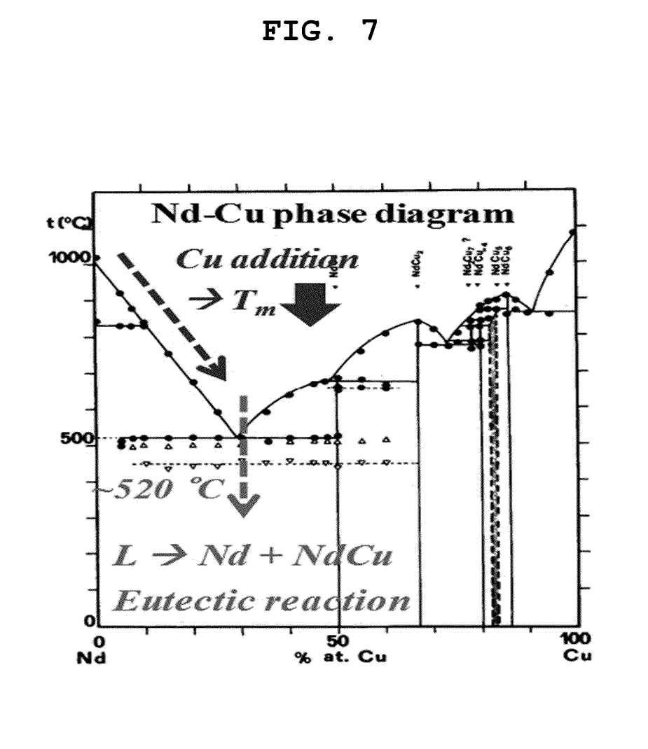

FIG. 6 and FIG. 7 are diagrams to explain effect of post-sintering annealing in the method for manufacturing a permanent magnet according to one embodiment of the present invention.

FIG. 6 shows microstructure subjected to post-sintering annealing.

In order to improve coercive force of the Nd—Fe—B sintered magnet, post-sintering annealing is necessary. Namely, in order to reduce the content of Dy, which is an expensive heavy rare earth element, the post-sintering annealing is one of very efficient methods. The coercive force of the sintered magnet is greatly influenced by microstructure of a non-magnetic Nd-rich triple point phase and a grain boundary phase. The effects of the annealing are as follows.

First of all, continuity of the Nd-rich grain boundary phase may be improved by annealing. Due to this, coercive force is improved by inhibiting exchange coupling between adjacent ferromagnetic main phases.

Further, defects on the interface are reduced by improved homogeneity of the Nd-rich triple point phase and the grain boundary phase. Due to this, nucleation site of reverse domain is reduced, thereby coercive force may be improved.

And the metastable C-type Nd₂O₃ triple point phase and the grain boundary phase are formed. Due to this, unconformity between the main phase and lattice is much reduced, thereby coercive force may be improved.

In improvement of coercive force by annealing, addition of a low melting point element such as Al, Ga, Ag, Cu and the like is very important. Among them, addition of Cu is most efficient because the Cu reduces the melting point of the Nd-rich phase most efficiently.

FIG. 7 is a diagram to explain effect of post-sintering annealing the powder containing Cu.

The effects of annealing after adding the Cu are as follows.

First of all, the melting point of the Nd-rich phase is reduced, thereby continuity and homogeneity of the grain boundary phase are further improved.

Further, non-magnetism of the Nd-rich triple point phase and the grain boundary phase is improved by process decomposition reaction between Nd and Cu, which is formed at about 520° C., thereby coercive force may be further improved.

Formation of the metastable C-type Nd₂O₃ triple point phase and the grain boundary phase is further accelerated.

When the Cu is added excessively, density of the sintered magnet may be reduced. For example, if the Cu content exceeds about 0.8 at %, density of the sintered magnet is reduced.

It is known that the existing ideal Cu content is about 0.1 to 0.2 at %. However, it is not clarified why the ideal Cu content is 0.1 to 0.2 at %.

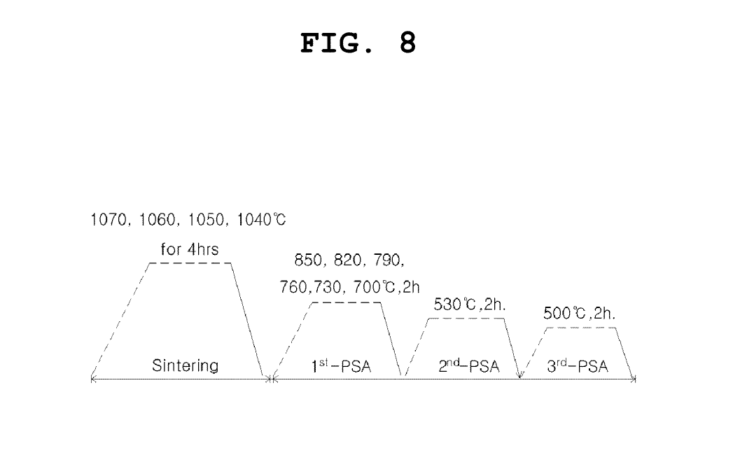

FIG. 8 shows performing sintering and annealing by a general method when manufacturing a permanent magnet.

The illustrated Test Examples are Test Examples about sintering and annealing to the sintered magnet according to the first Example having composition of Nd_{12.00}Dy_{2.70}Fe_{(76.45-x)}CuₓB_{6.00}M_{2.65} (x=0.2, 0.3, 0.4, 0.5) a sintered magnet according to the second Example having composition of Nd_{32.00}Fe_{(64.79-x)}CuₓB_{0.97}M_{2.24} (Dy-free) (x=0.2, 0.3, 0.4, 0.5) (at %, M=Co, Al, and Nb), and a sintered magnet according to the third Example having composition of Nd_{29.00}Dy_{3.00}Fe_{(64.79-x )}CuₓB_{0.97}M_{2.24} (3 wt % Dy-containing) (x=0.2, 0.3, 0.4, 0.5), (at %, M=Co, Al, and Nb).

As illustrated, the sintering temperature is 1040° C. to 1070° C. (1070, 1060, 1050, 1040° C.), and the sintering time is 4 hour. Further, the first annealing (PSA, Post-sintering annealing) temperature is 700° C. to 850° C. (850, 820, 790, 760, 730, 700° C.), and the annealing time is 2 hour. The second annealing temperature is 530° C., and the annealing time is 2 hour. The third annealing temperature is 500° C., and the annealing time is 2 hour.

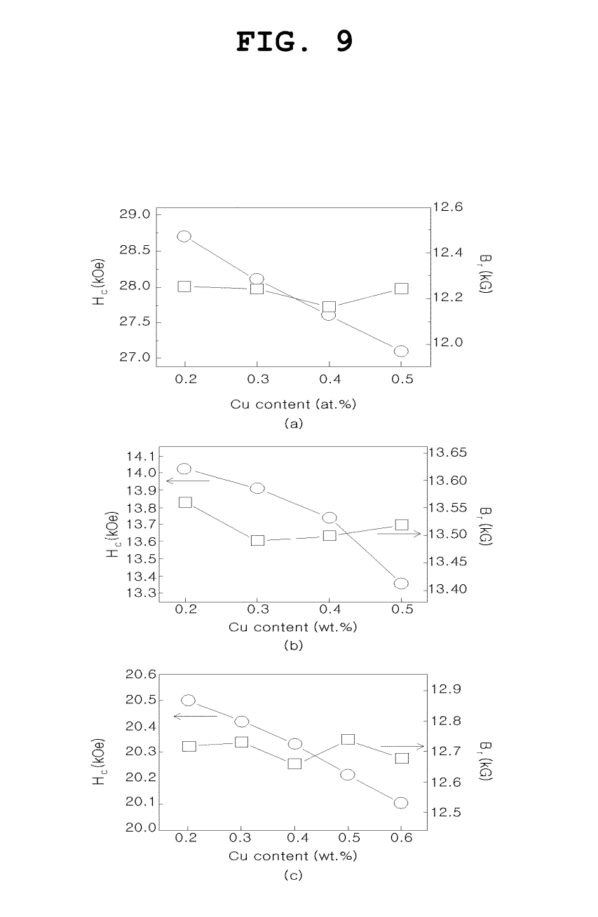

FIG. 9 is a diagram showing relationship between the Cu content and coercive force for Test Example according to FIG. 8. FIG. 9(a) is related to the first Example, FIG. 9(b) is related to the second Example, and FIG. 9(c) is related to the third Example.

According to FIG. 9(a), as the Cu content is increasing, coercive force is being reduced (28.7->27.1 kOe) as expected. And residual magnetization is not much changed.

According to FIG. 9(b), as the Cu content is increasing, coercive force is being reduced (14.0->13.3 kOe) as expected. And residual magnetization is not much changed.

According to FIG. 9(c), as the Cu content is increasing, coercive force is being reduced (20.5->20.1 kOe) as expected. And residual magnetization is not changed.

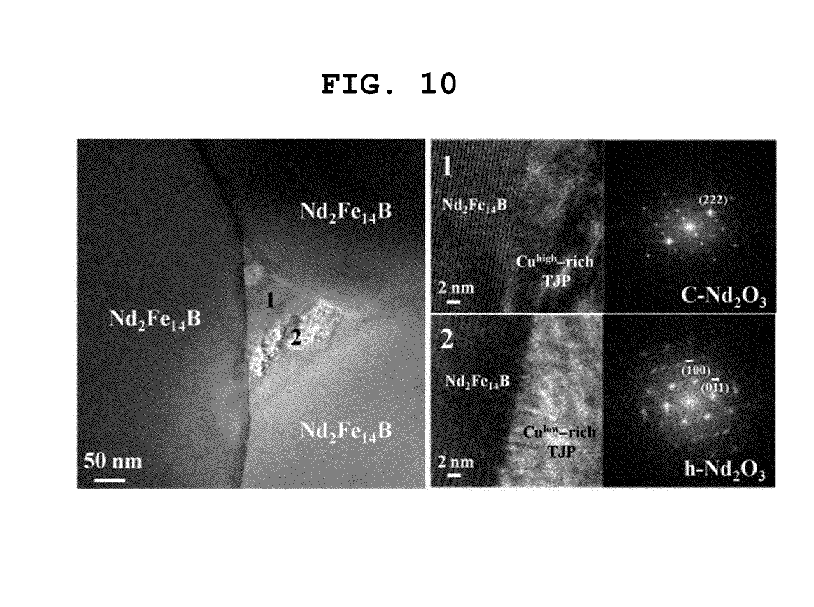

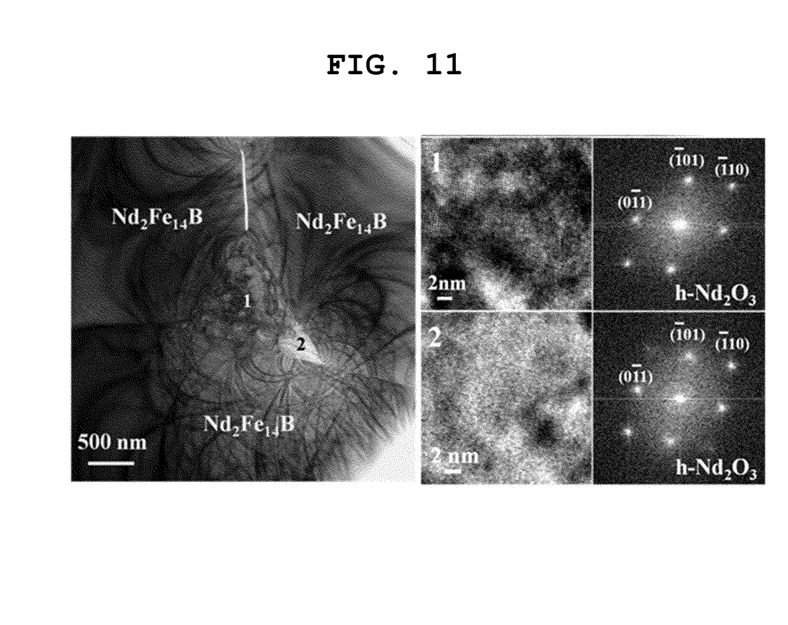

FIG. 10 to FIG. 11 show microstructure of the triple point phase of a permanent magnet containing 0.2 at % of Cu.

As illustrated, the microstructure forms layer structure. The dark area has composition of Nd₄₀Cu₃₄CO₄O₂₂, and the excess amount of Cu is flocculated. Further, the dark area shows C-type Nd₂O₃ crystal structure.

On the other hand, the light area has composition of Nd₄Cu₆Co₇O₄₇ and the small amount of Cu is flocculated. The light area shows the stablest phase, hexagonal Nd₂O₃ crystal structure.

Flocculation of the excess amount of Cu stabilizes metastable C-type Nd₂O₃ phase. From the layer structure, flocculation mechanism of the excess amount of Cu is process decomposition reaction between Nd and Cu, which can be formed during the third annealing.

FIG. 11 shows microstructure of the Nd-rich triple point phase of a magnet, which contains 0.5 at % of Cu.

Microstructure of FIG. 11 also shows similar microstructure with the layer structure like FIG. 10.

The dark area has composition of Nd_{45.2}Cu_{36.8}CO_{2.1}O_{15.9}, and the excess amount of Cu is flocculated. However, the structure of the dark area is not C-type Nd₂O₃ but hexagonal Nd₂O₃.

The light area has composition of Nd_{52.8}Cu_{11.6}Co_{1.6}O₃₄, the small amount of Cu is flocculated. The light area shows the stablest phase, hexagonal Nd₂O₃ crystal structure.

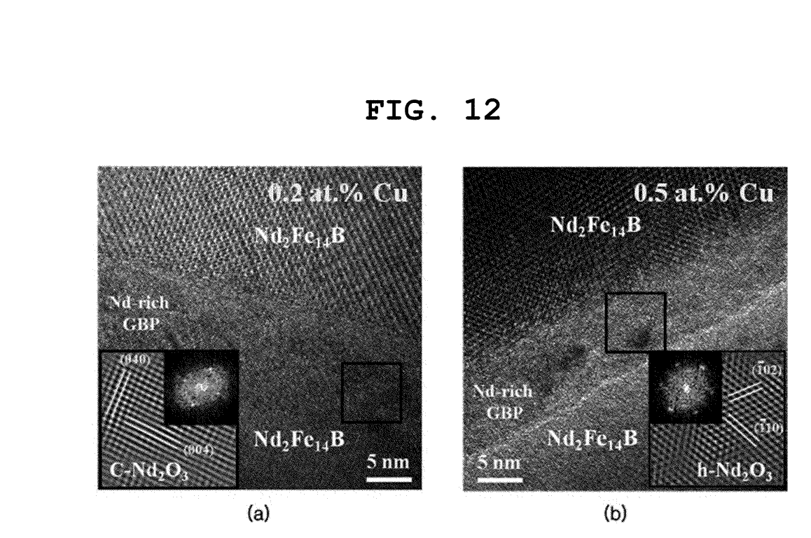

FIG. 12 is a diagram to compare microstructures of the Nd-rich grain boundary phases having different Cu contents.

Through FIG. 12, microstructures of the Nd-rich grain boundary phase, which plays the most important role to coercive force, can be compared.

FIG. 12(a) represents the case that the Cu content is 0.2 at %, and in this case, amorphous grain boundary phase of C-type Nd₂O₃ is formed.

FIG. 12(b) represents the case that the Cu content is 0.5 at %, and in this case, amorphous grain boundary phase of hexagonal Nd₂O₃ is formed.

It can be assumed that coercive force is reduced due to this difference in an aspect of crystal structure transformation of the Nd-rich phase.

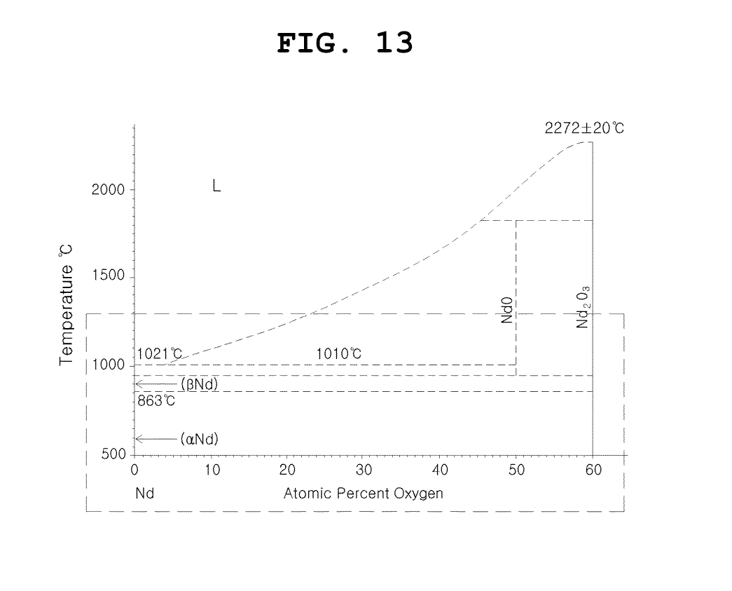

FIG. 13 shows an Nd—O binary phase diagram.

As illustrated, the melting point of the Nd-rich phase is reduced when adding Cu. This may mean that not only the melting point but also a phase transformation temperature is reduced.

Through DSC analysis and calculation, change on the phase transformation temperature may be assumed.

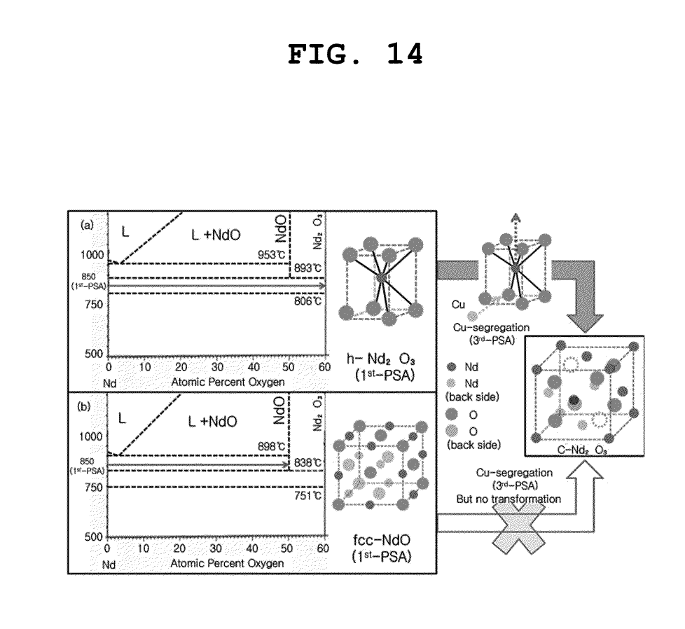

FIG. 14 is a diagram to explain relationship between the Cu content and the annealing temperature.

FIG. 14(a) represents the case that the Cu content is 0.2 at %. It can be found that the temperature is more reduced than the case of Cu-free overall, and the stable hexagonal Nd₂O₃ phase is stabilized at the first annealing temperature, 850° C.

FIG. 14(b) represents the case that the Cu content is 0.5 at %. It can be found that the phase transformation temperature is much reduced overall, and therefore, not the stable hexagonal Nd₂O₃ phase but the fcc-NdO phase is stabilized at the first annealing temperature, 850° C.

Namely, the metastable C-type Nd₂O₃ crystal may be derived from h-Nd₂O₃ crystal structure. These two crystals are closely related. Thus, when the excess amount of Cu is flocculated at an interstitial site of the hexagonal Nd₂O₃ phase, the phase may be transformed to the C-type Nd₂O₃ crystal.

However, in the case of the fcc-NdO having rock salt structure, this crystal structure can't be transformed to the C-type Nd₂O₃ phase even if the excess amount of Cu is flocculated. There is no interconnection between the two. Eventually, the structure can be transformed to the stable hexagonal Nd₂O₃ during the second and the third annealing. In the magnet where the 0.5 at % of Cu is added, not the C-type but the hexagonal phase is observed in spite of flocculation of the excess amount of Cu, thereby coercive force is reduced. Thus, it is needed to change the first annealing temperature depending on the Cu content.

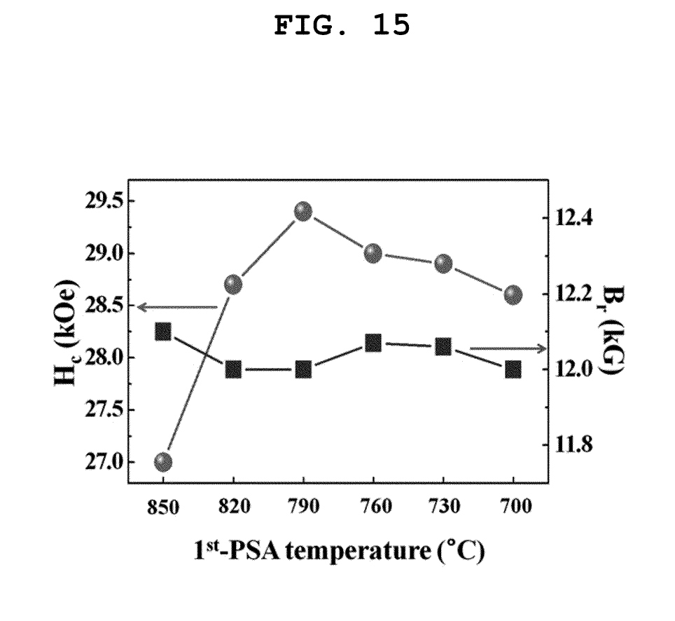

FIG. 15 shows coercive force change and residual magnetization change of the sintered magnet containing 0.5 at % of Cu according to the first annealing temperature.

When reducing the temperature to 790° C. rather than the existing 850° C., coercive force is much improved (27.1->29.4 kOe). Thus, the trace amount of the existing ideal Cu (Cu addition according to Example of FIG. 8) might not the ideal composition.

When changing the first annealing temperature depending on the Cu content, coercive force may be further improved. Consequently, coercive force of the sintered magnet may be improved without adding Dy. Namely, a Dy reduction type sintered magnet may be manufactured by adding cheap Cu and optimizing the annealing condition depending on the Cu content.

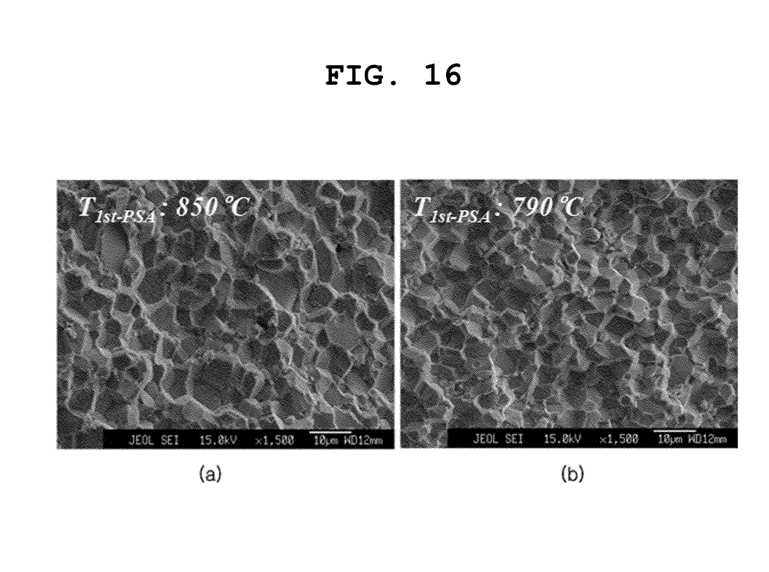

FIG. 16 is a diagram showing microstructures of specimens when annealing is conducted at the annealing temperature illustrated in FIG. 8 and the annealing temperature illustrated in FIG. 15.

FIG. 16(a) shows microstructure subjected to annealing at the annealing temperature of 850° C. according to the existing method, and FIG. 16(b) shows microstructure subjected to annealing at the annealing temperature of 790° C., which is changed depending on the Cu content.

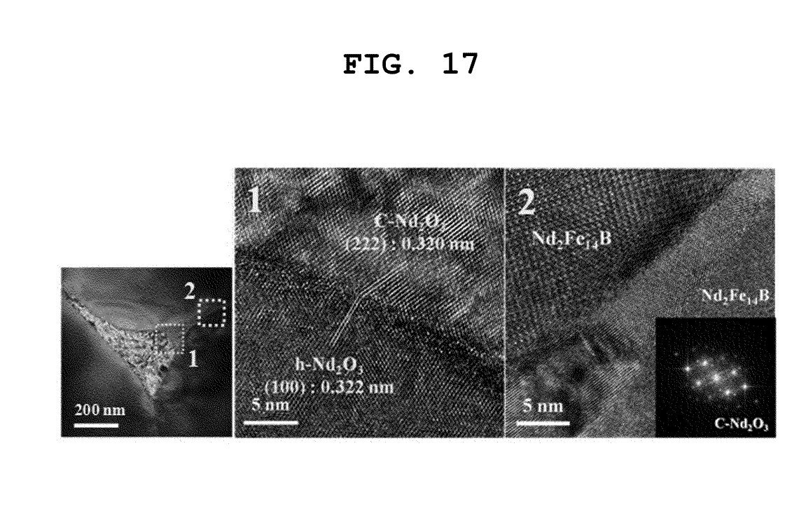

FIG. 17 is an image obtained from FIG. 16(b) by using High-resolution transmission electron microscopy (HRTEM).

Crystal grain is refined due to the reduced first annealing temperature. This may attribute to coercive force improvement.

In the cases of the Nd-rich triple point phase and the grain boundary phase, metastable C-type Nd₂O₃, where the excess amount of Cu is flocculated, is also formed again. This may attribute to coercive force improvement.

Further, through the illustrated Example, it can be confirmed that the annealing temperature is reduced as the Cu content is increasing.

On the other hand, in the permanent magnet manufactured according to another embodiment of the present invention, magnetic characteristic is changed according to the sintering temperature when manufacturing.

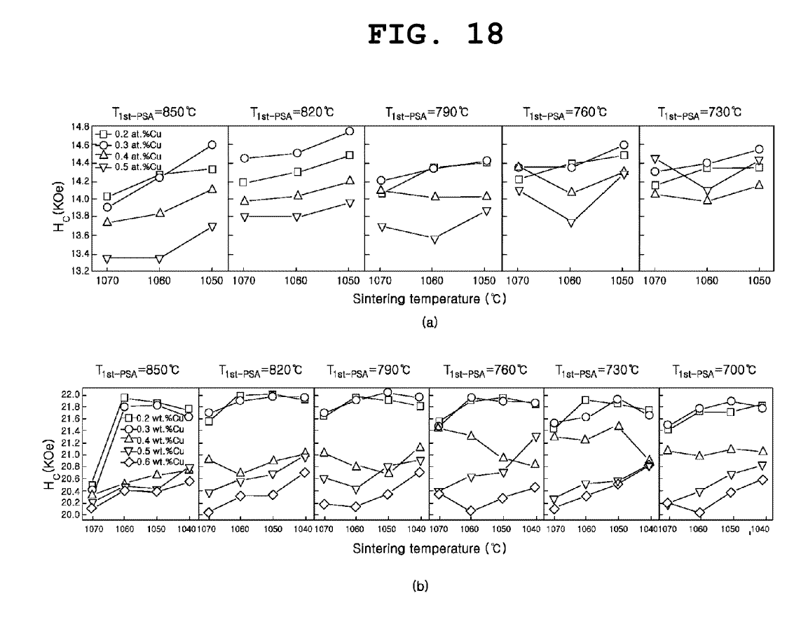

FIG. 18 is a graph showing change on magnetic characteristic according to the sintering temperature according to one embodiment of the present invention.

FIG. 18(a) represents change on magnetic characteristic according to the sintering temperature of the permanent magnet according to the first Example, and FIG. 18(b) represents change on magnetic characteristic according to the sintering temperature of the permanent magnet according to the second Example.

According to FIG. 18(a), coercive force tends to be increased as the sintering is being reduced. Further, in the case of a specimen having high Cu content (0.4, 0.5 wt %), coercive force is low, but coercive force tends to be increased as the first annealing temperature and the sintering temperature are being reduced. When the first annealing is conducted at 820° C., coercive force of the specimen having the Cu content of 0.3 wt % is the highest. The highest coercive force is obtained when the Cu content is 0.3, the sintering temperature is 1050° C., and the first annealing temperature is 820° C.

According to FIG. 18(b), coercive force tends to be increased as the sintering temperature is being reduced. In particular, in the case of a specimen, where 0.2 and 0.3 wt % of Cu is added, when the first annealing temperature is 850° C., coercive force is rapidly increased when reducing the sintering temperature from 1070° C. to 1060° C. Likewise, the highest coercive force is obtained from the specimen having the Cu content of 0.3 wt % (sintering temperature: 1050° C./first annealing temperature: 790° C.)

Only difference between FIG. 18(b) and FIG. 18(a) is that in the case of the specimen where Dy is added in an amount of 3 wt % Cu content, coercive force is not much increased when the Cu content is high (0.5, 0.6 wt %) even if the first annealing and the sintering temperature are reduced.

On the other hand, the permanent magnet manufactured according to another embodiment of the present invention, coercive force is changed according to change of the first annealing temperature when manufacturing.

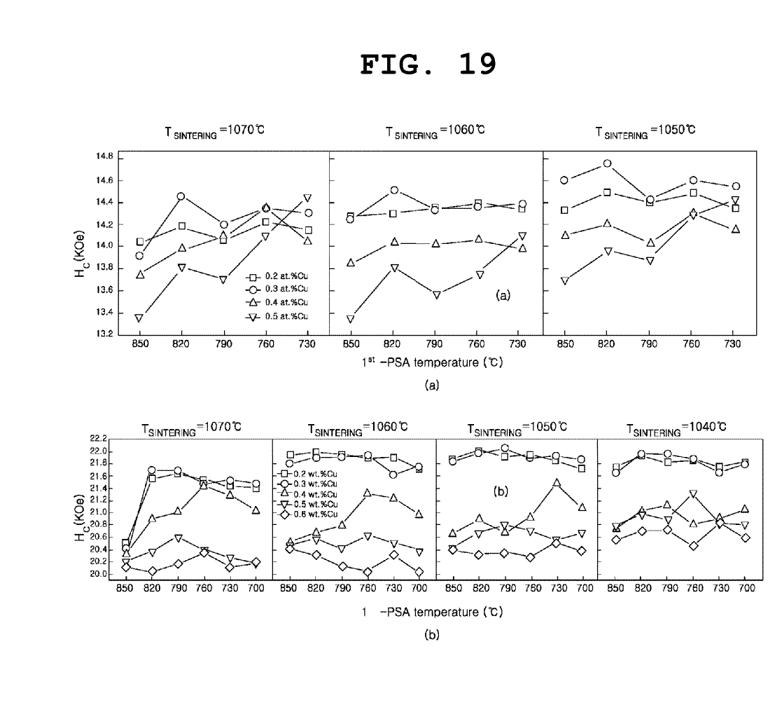

FIG. 19 is a graph showing coercive force change according to the first annealing temperature change according to one embodiment of the present invention.

FIG. 19(a) represents coercive force change of the permanent magnet according to the first Example depending on the first annealing temperature change, and FIG. 18(b) represents coercive force change of the permanent magnet according to the second Example depending on the first annealing temperature change.

According to FIG. 19(a), as the Cu content is increasing, the optimum first annealing temperature is reduced. Further, as the sintering temperature is reducing, overall coercive force tends to be increased.

According to FIG. 19(b), as the Cu content is increasing, the optimum first annealing temperature also tends to be reduced. Further, like FIG. 19(a), as the sintering temperature is reducing, overall coercive force tends to be increased.

As described above, the method for manufacturing a permanent magnet according to one embodiment of the present invention can manufacture a permanent magnet having an improved coercive force while reducing the amount of expensive Dy used by varying the sintering temperature or the annealing temperature depending on the Cu content.

The method for manufacturing a permanent magnet according to one embodiment of the present invention can manufacture an Nd—Fe—B-based permanent magnet having an improved coercive force while reducing the amount of Dy used, by varying the annealing temperature according to the content of Cu as an additive, when manufacturing the permanent magnet.

In the method for manufacturing a permanent magnet as described above, the configuration and the method of the above-mentioned exemplary embodiments are not restrictively applied. That is, all or some of the respective exemplary embodiments may be selectively combined with each other so that they may be various modified.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method for manufacturing a permanent magnet, which comprises: preparing powder including Nd, Fe, B and Cu; preparing a shaped body by forming a specific magnetic field in the powder; sintering the shaped body at a specific sintering temperature; and subjecting the sintered, shaped body to annealing at an annealing temperature determined according to the Cu content.

2. The method for manufacturing a permanent magnet of claim 1, wherein the annealing step comprises a plurality of annealings, and the annealing temperature determined according to the content of Cu is a first annealing of the plurality of annealings.

3. The method for manufacturing a permanent magnet of claim 1, wherein the content of Cu is 0.01 to 0.8 weight ratio to the powder.

4. The method for manufacturing a permanent magnet of claim 3, wherein the annealing temperature determined by the content of Cu is reduced as the content of Cu is increasing.

5. The method for manufacturing a permanent magnet of claim 1, wherein the specific sintering temperature is determined according to the content of Cu.
